(19) United States
(12) Patent Application Publication
(10) Pub. No.: US 2003/0184493 A1
(43) Pub. Date: Oct. 2, 2003

(54) Multi-part reception antenna

(76) Inventors: Antoine Robinet, Grenoble (FR); Thierry Thomas, Varces (FR)

Correspondence Address: Robert EI Krebs, Thelen Reid & Priest LLP, P.O. Box 640640, San Jose, CA, 95164-0640, US

(21) Appl. No.: 10/405,180

(22) Filed: Apr. 1, 2003

(30) Foreign Application Priority Data
Apr. 2, 2002 (FR) 02 04065

(51) Int. Cl. H01Q 21/00; H01Q 11/12

(52) U.S. Cl. 343/867; 343/742

(57) ABSTRACT

A reception antenna (2) in a reception device (1) including an object (10) designed to be remote controlled by electromagnetic coupling with at least one emission antenna (8). This reception antenna (2) is designed to be connected to the object (10) and is separated into several looped parts (2.1, 2.2) arranged in parallel, these looped parts (2.1, 2.2) each having an area (s1, s2), these areas (s1, s2) being globally placed adjacent to each other such that the looped parts (2.1, 2.2) are coupled successively and continuously to the emission antenna (8).

Application to remote transmission.

### CROSS REFERENCE TO RELATED APPLICATION

This application claims priority based on French Patent Application No. 02 04065 filed Apr. 2, 2002, entitled “Multi-Part Reception Antenna”.

### DESCRIPTION

1. Technical field

This invention relates to a reception antenna in a reception device including an object remote controlled from an emission device. The reception device and the emission device communicate without contact, which is particularly useful if they are moving relative to each other.

For example, the application domain may be tires, machine tools, printing, counting of articles or persons, etc.

2. State of Prior Art

The emission device is designed for transmission of energy and/or information to an object that may be a sensor, a counter or a device performing another function. The purpose may be to communicate data such as signals related to measurements, counting or other purposes, to the emission device.

Therefore, the purpose is related to at least one first inductive antenna called the reception antenna that must be electromagnetically coupled with at least one second inductive antenna called the emission antenna in the emission device. This emission device will supply energy to the object, and/or control its operation and if applicable retrieve data supplied to it. The two antennas are formed from a loop conductor laid out in one or several turns. The two antennas will communicate close to a working frequency ft. The principle is to generate an electromagnetic field from the emission device at the working frequency ft through which the energy and/or information will be transmitted.

The energy is transmitted by the carrier, and depends on the amplitude of the carrier.

In addition to the emission antenna, the emission device comprises electronic means for generating the working frequency ft and a modulation stage so that information can be transmitted in electromagnetic form near the working frequency towards the object. The information is transmitted by amplitude, frequency or phase modulation of this carrier.

The emission device may also comprise means of processing data received from the object.

The reception device comprises means cooperating with the object and designed to shape the received signals, possibly including a rectifying circuit.

Patent application FR-A1-2 771 965 describes a reception device with a reception antenna connected to a sensor, the antenna and the sensor being installed in a tire. The antenna is designed to be electromagnetically coupled with another antenna located outside the tire. The reception antenna is rectangular when it is made flat, and extends along the periphery of the tire under its tread.

The working frequency ft is an important parameter since it controls the characteristics of the reception antenna of the reception device and the characteristics of the emission antenna of the emission device. The reception antenna has a self-resonant frequency that depends on its intrinsic characteristics, in other words the resistance of its conductor, the length of its conductor, the value of the intrinsic capacitance distributed along its conductor, its area, in other words the area of one turn of its conductor, and external characteristics related to its environment such as the magnitude of the parasite capacitances, the capability of the medium to channel magnetic field lines.

For optimum operation, the reception antenna of the reception device must be matched to the working frequency ft. Matching is usually done using a matching capacitor installed in parallel with the antenna. When matching, the following relation is satisfied:

LC(2πft)²=1 where L is the inductance of the reception antenna, and C is the global capacitance of the reception antenna. These magnitudes L and C are magnitudes equivalent to the working frequency seen by the reception device. For example, C will be the sum of all capacitances involved at the reception antenna intrinsic capacitance of the antenna, parasite capacitance and capacitance of the matching capacitor.

Among the working frequencies authorized by AFNOR standards and which correspond to the ISM bands, a working frequency of the order of about ten Megahertz will be chosen. With a higher frequency it would be difficult to transmit the energy, and with a lower frequency the information throughput would be too low. At this working frequency, the low power levels involved during transmission with the emission device, ambient noise and the compact dimensions imposed on the emission device, the area of the reception antenna of the reception device is large compared with the area of the emission antenna of the emission device.

The result is that there is a self-resonant frequency that is less than the working frequency ft, due to a high inductance and a high intrinsic capacitance distributed along the conductor and seen by the object. Frequently, there are also large parasite capacitances due to the antenna environment. For example, this is particularly the case for tires or in printing, for which metallic elements inevitably come into contact with the reception antenna. Specially shaped antennas, for example long narrow antennas, also reduce the self-resonant frequency.

If the self-resonant frequency of the reception antenna is too low compared with the working frequency ft, it is impossible to match the reception antenna of the reception device to the working frequency ft since the value of its intrinsic capacitance is already too high to achieve a match. Adding a matching capacitor would only make the situation worse. If a match is not achieved, coupling between the reception antenna and the emission antenna cannot be optimum and the transmission efficiency is not good. Nor is it possible to reduce the area of the reception antenna in order to achieve a match, since this would deteriorate the coupling quality.

Presentation of the Invention

This invention is intended to overcome the disadvantages mentioned above, and particularly is designed to easily achieve a match between the reception and emission antennas in a large number of configurations and environments without needing to reduce the area of the reception antenna connected to the object or to lower the working frequency.

To achieve this, the purpose of this invention is a reception antenna in a reception device that includes at least one object that will be remote controlled by electromagnetic coupling with at least one emission antenna. The reception antenna will be connected to the object and is separated into several looped parts arranged in parallel. The looped parts each have an area and these areas are globally placed adjacent to each other such that the looped parts are coupled successively and continuously to the emission antenna.

The reception antenna has a useful reception area and the sum of the areas of all the looped parts is approximately equal to the useful area of the reception antenna.

With this structure, the area of the reception antenna is advantageously much greater than the area of the emission antenna.

In order to obtain good coupling with the emission antenna, it is preferable if the looped parts are formed from a conductor, a conductor portion in a first looped part and a conductor portion in a second looped part close to the first looped part being separated by the smallest possible space.

Similarly, it is preferable if the two looped parts are separated on the side of the object by the smallest possible space.

To facilitate matching between the emission antenna and the reception antenna, a matching capacitor may be installed in parallel with at least one of the looped parts. The antenna is advantageously shielded to reduce its electrical radiation, particularly close to the object.

This invention also relates to a reception device that comprises at least one reception antenna thus defined.

It is preferable if in this type of reception device, the reception antenna should be connected to the object through a shaping means including at least one rectifying circuit.

The shaping means may comprise a single rectifying circuit, the looped parts having at least one end connected to the rectifying circuit at the input, and the object being connected to the output of the rectifying circuit.

According to another embodiment, the shaping means may comprise several rectifying circuits, each looped part having at least one end connected to the input of one of the rectifying circuits, the rectifying circuits having their outputs connected in series with the object.

This type of reception device may be free to move relative to the emission antenna.

### BRIEF DESCRIPTION OF THE DRAWINGS

This invention will be better understood after reading the description of example embodiments given for guidance purposes only and in no way limitative, with reference to the attached drawings in which:

FIG. 1A shows an example of a reception antenna according to the invention in a tire application;

FIG. 1B shows an example of a reception antenna according to prior art;

FIGS. 2A, 2B, 2C and 2D show several variants of the connection between the reception antenna and the object to be remote controlled;

FIGS. 3A and 3B show another example of a reception antenna according to the invention and a detail of its connection with the object, respectively;

FIG. 4 shows an example of a plane and circular reception antenna;

FIG. 5 shows an example of a reception antenna for which the surface is a portion of the lateral surface of a cylinder with an ellipsoidal directrix;

FIG. 6 shows an example of a reception device according to the invention in a vehicle counting or identification application.

In these figures, identical elements are denoted by the same reference characters and the drawings are not to scale.

### DETAILED PRESENTATION OF PARTICULAR EMBODIMENTS

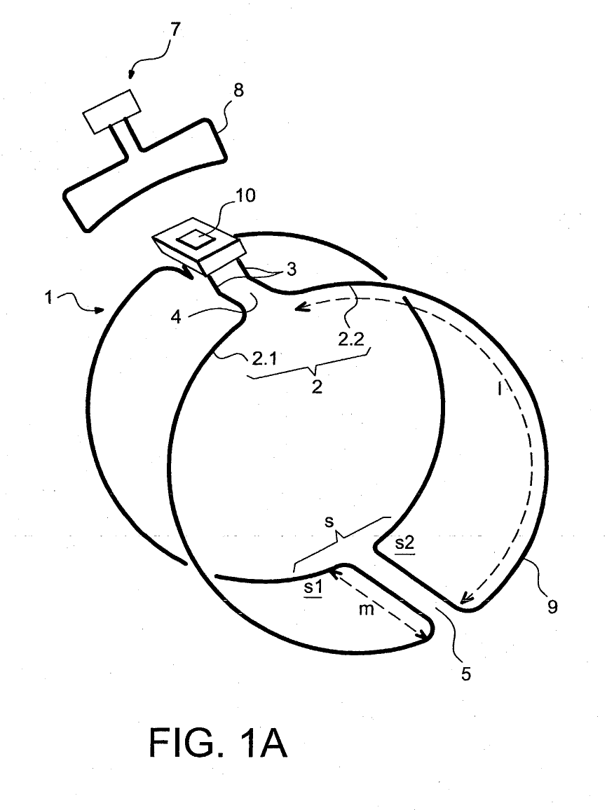

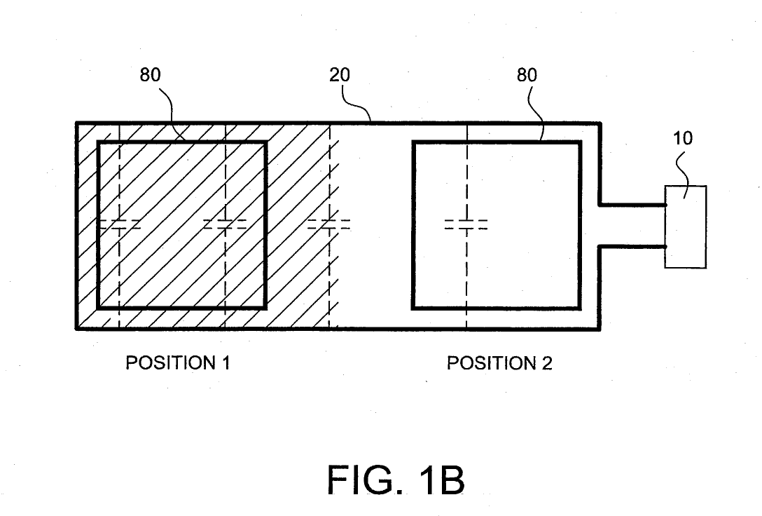

We will now refer to FIG. 1A. The figure shows a reception device 1 comprising at least one object 10 that will be remote controlled from an emission device 7. Remote control means either remote supply of energy to the object, or remote communication between the object and the emission device, or both functions.

The object 10 will be connected to at least one reception inductive antenna 2 that will electromagnetically be coupled to at least one other emission inductive antenna 8 of the emission device 7.

For example, the object may be a sensor, a counter or an electronic label. The object and the electronic circuit adapted to it may advantageously be shielded in an electric field.

The reception antenna 2 connected to the object is formed from several looped parts 2.1 and 2.2. The different looped parts 2.1 and 2.2 are arranged in parallel. The looped parts in all the figures are represented in the form of a conductor 9 arranged in a single turn, although obviously they could have several turns.

The area of each looped part 2.1, 2.2 corresponds to the area of a turn and these areas reference s1, s2 are globally adjacent to each other. This means that in general, their areas are side by side and not facing each other. The looped parts 2.1 and 2.2 are then coupled in sequence and continuously to the emission antenna 8. Coupling can then be continuous regardless of the relative position between the emission device 7 and the reception device 1.

The reception antenna 2 then has a useful reception area s approximately equal to the sum of the areas s1, s2 of the different looped parts 2.1, 2.2. The useful area means the maximum area effectively used for transmission and for which line losses are acceptable.

When the reception antenna 20 is not broken down into several parts as in prior art, only part of this area is useful. Refer to FIG. 1B. A conventional large and approximately rectangular reception antenna 20, and an approximately square emission antenna 80 are coupled with each other, facing each other and are approximately plane. The reception antenna 20 is connected to an object 10. When the two antennas 20, 80 are coupled together, an electrical current passes through the reception antenna 20. But when the emission antenna 80 is far from the connection between the reception antenna 20 and the object 10 (position 1), almost no signal reaches the object due to inevitable line losses particularly due to parasite capacitances, and coupling is not satisfactory. However, when the emission antenna 80 is close to the connection between the reception antenna 20 and the object 10 (position 2) the signal arrives satisfactorily at object 10 almost without losses. The reception antenna 20 has a useless zone that is materialized by crosshatching, and its useful area is smaller than its real area. This useless area is eliminated in the invention by separating the reception antenna into several parts.

It is assumed that the example in FIG. 1A relates to use for tires. In this application, the emission device 7 would be outside the tire, for example located on the vehicle itself, this emission device 7 could include the vehicle battery for the energy supply and it could be provided with an emission antenna 8. The emission antenna 8 can be located in the vehicle wing facing the reception antenna 2. For example, the object 10 may comprise at least one measuring device such as a force sensor, a temperature sensor, a pressure sensor and/or at least one control device.

Each of the looped parts 2.1, 2.2 will be located under the tread of the tire.

The area s of the reception antenna 2 is approximately a lateral area of a cylinder of revolution and corresponds approximately to the area of the tread of the tire. The shape of the conductor 9 of the looped parts 2.1, 2.2 is approximately rectangular when it is laid out flat, and when it is in position it extends over portions of the side surface of the cylinder of revolution. A portion 1 of the conductor 9, corresponding to the large side of the rectangle, goes around the periphery of the tire and a portion m of the conductor 9, corresponding to the small side, goes across its width. In the example described with two approximately identical looped parts 2.1, 2.2, the small sides of the rectangles are equal to about 10 to 10.5 centimeters, which is slightly less than the width of a standard tire, while their large sides will be approximately one meter long, which is about half the length of the tread.

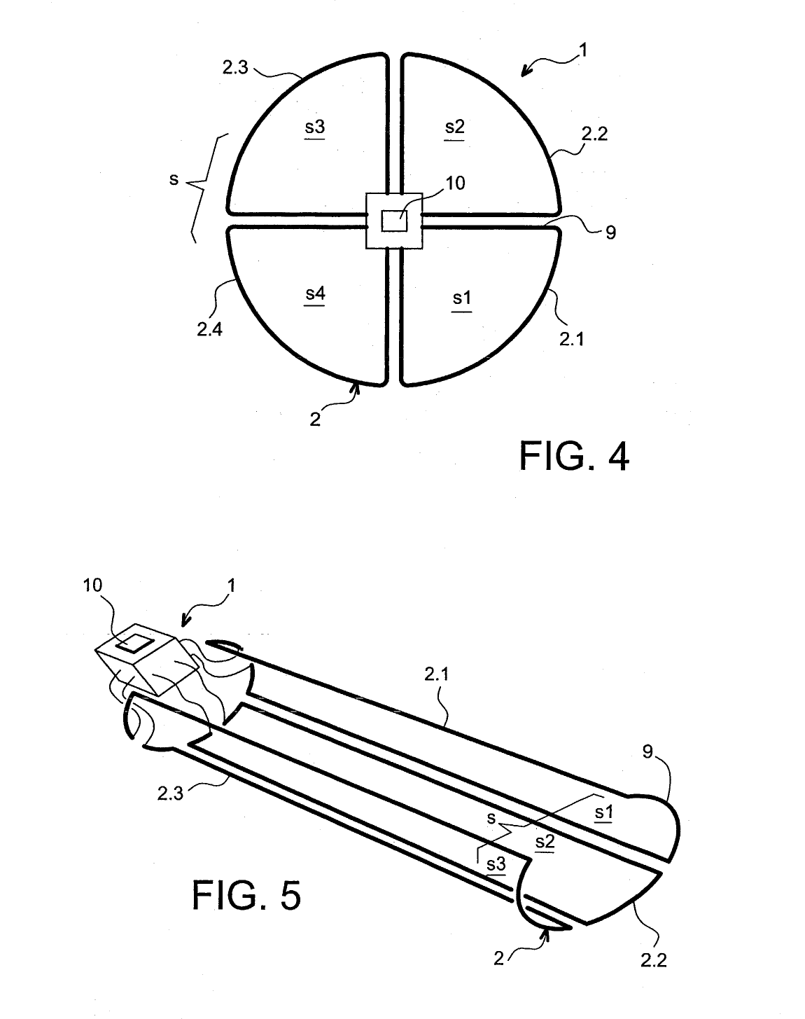

The various looped parts 2.1, 2.2 have been shown identically, but this is not compulsory, they may have different shapes and/or sizes as can be seen in FIG. 5, however it is recommended that the looped parts should be symmetrical.

In separating the reception antenna 2 into several looped parts 2.1, 2.2 arranged in parallel and by bringing their surfaces into contact, its surface is almost not modified and its useful area is greater than the useful area of a single conventional antenna (like that shown in patent application FR-A1-2 771 965 which occupied most of the area of the tread), however the intrinsic capacitance of the reception antenna 2 as seen by the object 10, and the value of its inductance, are reduced.

When the lengths of the different looped parts 2.1, 2.2 are the same, the intrinsic capacitance of the reception antenna 2 is approximately equal to the intrinsic capacitance of one of the looped parts, in other words its intrinsic capacitance is the same as the intrinsic capacitance of the single antenna according to prior art like that described in application FR-A1-2 771 965, divided by the number of looped parts.

By reducing the intrinsic capacitance of the reception antenna 2 by separating it into parts, the self-resonant frequency of each of the parts is significantly higher than the self-resonant frequency of the single antenna with an area equivalent to the area of all the parts. This makes it possible-to work at a much higher working frequency than before.

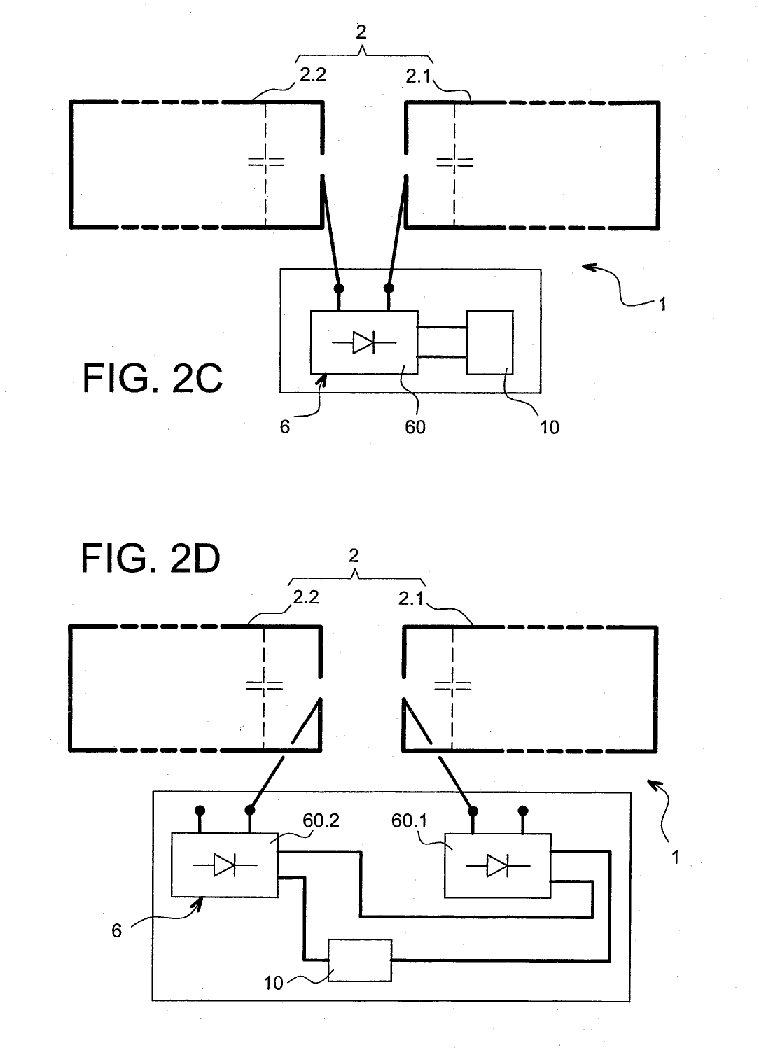

Matching can then be done either directly by choosing the number of looped parts and/or by choosing the geometry of the looped parts, or by an association of at least one matching capacitor installed in parallel with one of the looped parts. FIG. 1A does not show any matching capacitor, but there is one shown in FIG. 3B.

Conversely, the fact of using a multi-part antenna can increase the area by using several looped parts for which the areas are the same order of magnitude as the areas of a single conventional antenna.

The object 10 may be located within the tread of the tire, on the side of the grooves formed in the tread but remaining within a non-wearing part of the tread to guarantee that it will continue to operate throughout the life of the tire.

In FIG. 1A, the looped parts 2.1, 2.2 of the antenna are provided with two ends 3 which need to be electrically connected to the object 10, and these ends 3 are oriented approximately transverse to the tread. The two ends 3 are located in a portion m of the conductor 9 corresponding to a small side of the rectangle. The smallest possible space 4 separates two looped parts 2.1, 2.2 on the side of the object 10. For example, this space may be approximately 0.5 to 1 cm.

Similarly, as can be seen in FIG. 1A, on the side opposite the object 10, a space 5 separates two portions m of the conductor 9 belonging to adjacent looped parts. This space 5 is chosen to be as small as possible, for example of the order of 0.1 to 0.3 cm. Obviously, what is important is that the different looped parts 2.1, 2.2 do not have any electrical contact.

The area of the emission antenna 8 of the emission device 7 is smaller than the area of the reception antenna 2. In this application, its dimensions could be about 10 centimeters by 20 centimeters and the working frequency ft could be equal to 13.56 MHz.

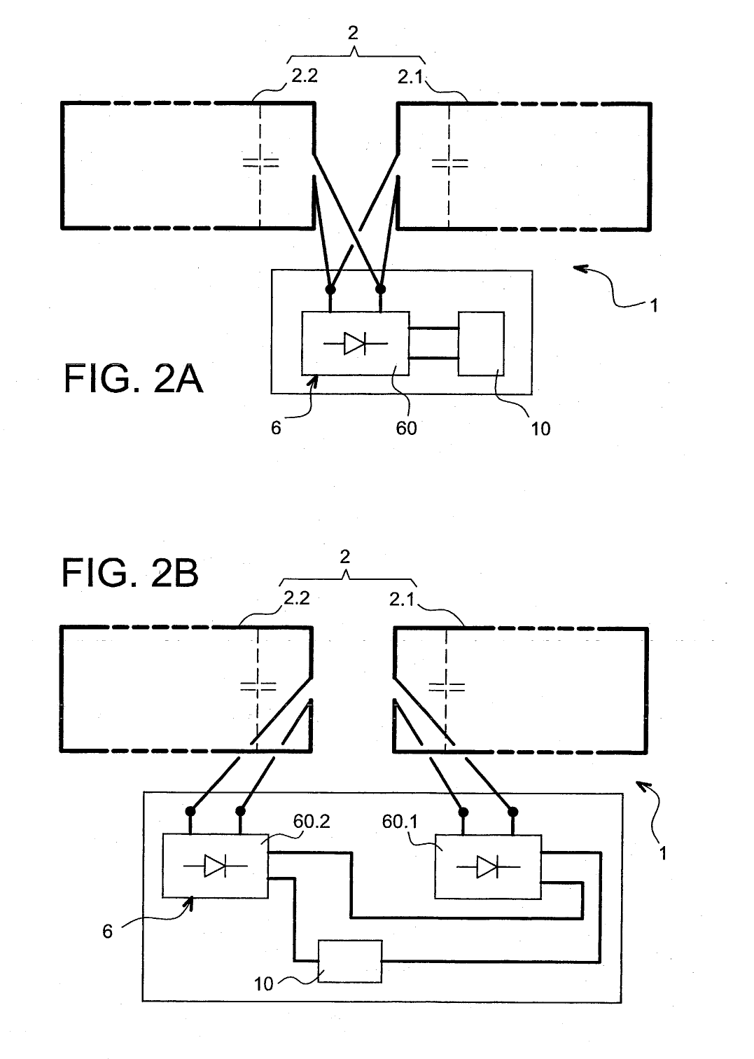

We will now consider the connection between the ends 3 of the looped parts 2.1, 2.2 of the reception antenna 2 and the object 10 and refer to FIGS. 2A, 2B. The looped parts 2.1, 2.2 are shown laid out flat to simplify the drawing. The connection is made through a shaping means 6.

This shaping means 6 may comprise a single shaping circuit 60 as shown in FIG. 2A, or several shaping circuits 60.1, 60.2 as shown in FIG. 2B. This shaping circuit includes at least one rectifying circuit.

In FIG. 2A, all looped parts 2.1 and 2.2 of the reception antenna 2 are connected in parallel to the input of the shaping circuit 60, the object 10 is connected to the output of the shaping circuit 60 and a rectified voltage is input to this shaping circuit, that depends on the voltages applied to the input of the shaping circuit from each of the looped parts 2.1, 2.2.

The parallel connection is made before rectification at the signal induced in the reception antenna.

In FIG. 2B, each looped part 2.1, 2.2 is connected to the input of a shaping circuit specific to it, namely 60.1, 60.2 respectively, and the outputs of the shaping circuits 60.1, 60.2 cooperate in series with the object 10 so that it receives the sum of voltages present at the output from the different shaping circuits 60.1, 60.2. In fact, since the looped parts work successively and continuously, the sum of the signals induced in each of the looped parts is never obtained at the object. The signals at the output from the shaping circuits are continuous and they can be summated, which is not possible before their conversion.

The configuration in FIG. 2A with a single shaping circuit 60 is more attractive from the cost and compactness point of view, but also because it is more robust against disturbances. It is better to make a single transformation on a sum signal than several transformations followed by a summation.

Furthermore, note that the looped parts do not need to be closed, in other words, the two ends of the looped parts do not need to be electrically connected to the object, a link with only one of these ends would be sufficient. Parasite capacitances due to the environment enable looping of the looped part onto the object. FIGS. 2C and 2D illustrate such a configuration. Each of the looped parts 2.1, 2.2 has one end “disconnected” and one end connected to the shaping means 6. The parasite capacitances are diagrammatically shown in dashed lines.

We will now describe other configurations of reception antennas conform with the invention. Refer to FIGS. 3A and 3B. These figures show an approximately plane reception antenna 2 for which the area is globally in the shape of a ring. It is formed from several approximately plane looped parts 2.1, 2.2 with an area being a portion of a ring, in this case half-rings, and these half-rings are placed adjacent to each other in the same plan to form the ring. The conductor 9 in each of the looped parts 2.1, 2.2 has two portions 1 forming a fraction of a circle and two radial portions m. Once again, two radial portions belonging to adjacent looped parts are separated by the smallest possible space 5.

The zoom in FIG. 3B shows an enlarged view of the connection of the looped parts 2.1, 2.2 to the object 10, without showing the shaping means to avoid making the figure too complicated. Matching capacitors c1, c2 were placed in parallel on each of the looped parts 2.1, 2.2, and are located at the ends 3 connected to the object 10.

This antenna 2 may be placed on a rotating support, for example for tires it may be located on the sidewall of the tire. The size of the radial portions m could be from about 2 to 4 centimeters, the portions 1 around a fraction of a circle could be of the order of one meter, the space 4 on the side of the object 10 separating the two looped parts 2.1, 2.2 could be about 0.5 to 1 centimeters, and the space 5 between two radial portions m of adjacent looped parts could be about 0.1 to 0.5 centimeters. In this example, the object 10 is located in the tire sidewall or in a non-wearing part of the tread.

In the field of rotating machines, the antenna would be fixed to an approximately plane face of a rotating part, for example the transverse face of a rolling mill cylinder. Once again, this type of reception antenna can be coupled to at least one small emission antenna, so that the reception device cooperates with a small emission device. Matching may be done on higher working frequencies than is possible for conventional reception devices with the same size of reception antenna.

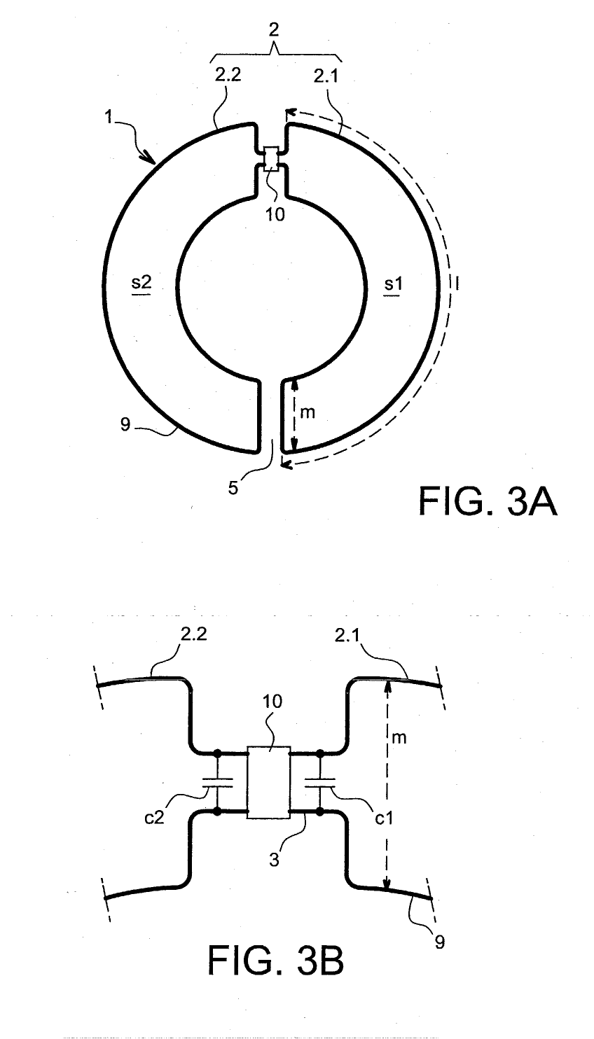

FIG. 4 shows that the reception antenna 2 has an approximately plane and circular area. It is formed of several looped parts 2.1, 2.2, 2.3 and 2.4, the area of each corresponding to a sector of a circle, the useful area s of the reception antenna being approximately equal to the sum of the areas s1, s2, s3, s4 of the looped parts 2.1, 2.2, 2.3, 2.4. The conductor 9 of the looped parts comprises two radial portions and a portion following a fraction of a circle. The looped parts are connected in parallel to the object 1 that is located in the central part of the circle. With this configuration the reception antenna 2 could be fixed, as before, for example on a transverse face of a rolling mill cylinder or a roll used in a printing shop, and for example the object 1 could possibly include a speed or acceleration sensor.

In FIG. 5, the reception antenna 2 is formed of several looped parts 2.1, 2.2 and 2.3 that are not plane. Each looped part is approximately rectangular when it is laid out flat, and its area s1, s2 and s3 extends along a portion of the lateral surface of a cylinder with an ellipsoidal directrix.

The useful area s of the reception antenna 2 also occupies a portion of the lateral surface of the cylinder with an ellipsoidal directrix. This type of reception antenna 2 may be fixed to a cylindrical support with an ellipsoidal directrix driven in an oscillating or rotation movement that may possibly be off-centered.

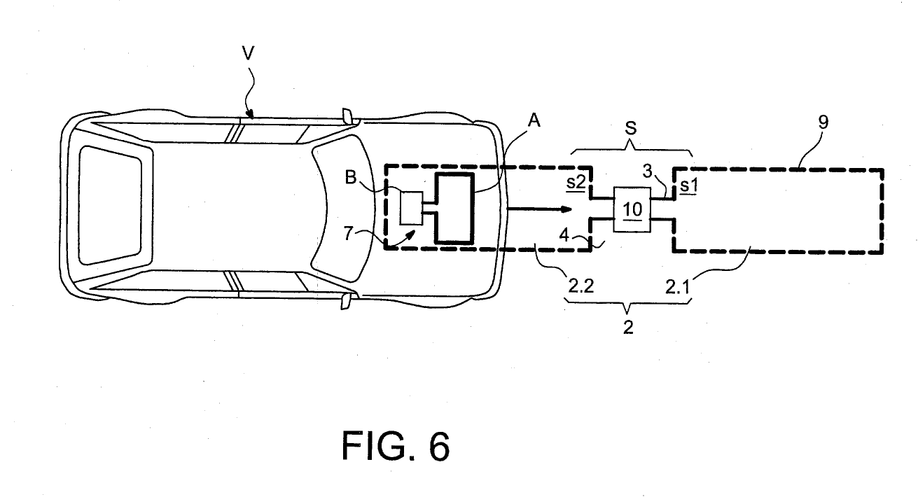

In FIG. 6, the reception antenna 2 is plane and is formed of two looped parts 2.1, 2.2 that are approximately rectangular and are put end to end and connected in parallel with an object 10 located between them. This type of reception antenna 2 and the associated object 10 forming the reception device 1 may for example be inserted in the ground along a path followed by vehicles V at the end of manufacturing. The object 10 may simply be a counter or, for example in a more sophisticated arrangement, a code acquisition device. The vehicles V to be counted or identified comprise an electronic box B with an emission antenna A to be electromagnetically coupled with the reception antenna 2, as an emission device 7. The area of the emission antenna is small compared with the area of the reception antenna 2. The movement of the vehicles and therefore the emission device 7 is a translation above the reception antenna 2. The reception antenna 2 is shown as being a long and narrow rectangle. The dimensions of its area may be approximately 2 meters by 20 centimeters, whereas the dimensions of the area of the emission antenna A may be of the order of about 20 centimeters by 10 centimeters.

The number of looped parts can be increased to occupy a greater working area if the emission antenna moves along a circular path instead of following a curvilinear movement.

Although several embodiments of this invention have been illustrated and described in detail, it can easily be understood that different changes and modifications could be made without going outside the scope of the invention. In particular, this invention is not limited to the described shapes of reception antennas.

1. Reception antenna (2) in a reception device (1) including an object (10) designed to be remote controlled by electromagnetic coupling with at least one emission antenna (8), this reception antenna (2) being designed to be connected to the object (10), characterized in that it is separated into several looped parts (2.1, 2.2) arranged in parallel, these looped parts (2.1, 2.2) each having an area (s1, s2), these areas (s1, s2) being globally placed adjacent to each other such that the looped parts (2.1, 2.2) are coupled successively and continuously to the emission antenna (8).

2. Antenna according to claim 1, characterized in that it has a useful reception area (s) approximately equal to the sum of the areas (s1, s2) of all the looped parts (2.1, 2.2).

3. Antenna according to claim 2, characterized in that its area (s) is advantageously much greater than the area of the emission antenna (8).

4. Antenna according to claim 1, characterized in that the looped parts (2.1, 2.2) are formed from a conductor (9), a conductor portion in a first looped part (2.1) and a conductor portion in a second looped part (2.2) close to the first looped part (2.1), being separated by the smallest possible space (5).

5. Antenna according to claim 1, characterized in that two looped parts (2.1, 2.2) are separated on the side of the object (10) by the smallest possible space (4).

6. Antenna according to claim 1, characterized in that a matching capacitor (c1, c2) is installed in parallel with at least one of the looped parts (2.1, 2.2) to match the said looped part (2.1, 2.2) to the emission antenna (8).

7. Reception device characterized in that it comprises at least one reception antenna (2) according to one of claims 1 to 6.

8. Reception device according to claim 7, characterized in that the reception antenna (2) is connected to the object (10) through a shaping means (6).

9. Reception device according to claim 8, characterized in that the shaping means (6) comprises a single rectifying circuit (60), the looped parts (2.1, 2.2) having at least one end connected to the rectifying circuit (60) at the input, the object (10) being connected to the output of the rectifying circuit (60).

10. Reception device according to claim 8, characterized in that the shaping means (6) comprises several rectifying circuits (60.1, 60.2), each looped part having at least one end connected to the input of one of the rectifying circuits (60.1, 60.2), the rectifying circuits (60.1, 60.2) having their outputs connected in series with the object (10).

11. Reception device according to claim 7, characterized in that it is free to move relative to the emission antenna (8).
